(19) United States
(12) Patent Application Publication
(10) Pub. No.: US 2022/0391994 A1
(43) Pub. Date: Dec. 8, 2022

(54) Automated Financial Document Processing and Bookkeeping System

(71) Applicant: Duke-AI, LLC, Dallas, TX (US)

(72) Inventors: Marcus Cooksey, Frisco, TX (US); Viswanath Puttgunta, Richardson, TX (US); Shubham Kothari, Plano, TX (US); Alex Osborn, Dallas, TX (US); Blake Donahoo, Garland, TX (US)

(21) Appl. No.: 17/829,335

(22) Filed: May 31, 2022

Related U.S. Application Data
(60) Provisional application No. 63/196,210, filed on Jun. 2, 2021.

(51) Int. Cl. G06Q 40/00; G06Q 40/02

(52) U.S. Cl. CPC G06Q 40/12; G06Q 40/025

(57) ABSTRACT

An automated financial document processing and bookkeeping system and method include a user application having an interface configured to capture images of financial documents associated with a user and transmit the document images to a remote server. The financial documents may include invoices, bills of lading, rate sheets, proof of delivery, lumper, receipts, purchase orders, bank statements, and driver settlement statements. The remote server has a document processing engine configured to receive the document images and automatically enhance the document images and extract financial data. The user may generate a number of financial reports including profit and loss, expenses, and tax liability reports. The system and method are further configured to compute a risk score indicative of a confidence level that a shipper will pay an invoiced amount for a delivered load in full, to enable a factoring payor to automate the processing of freight invoices in a speedy manner.

### RELATED APPLICATION

This application claims the benefit of U.S. Provisional Patent Application No. 63/196,210 filed on Jun. 2, 2021, the entirety of which is incorporated by reference.

### FIELD

The invention relates generally to an automated financial document processing and bookkeeping system.

### BRIEF DESCRIPTION OF THE DRAWINGS

A better understanding of the claimed subject matter can be obtained when the following detailed description of the disclosed embodiments is considered in conjunction with the following figures.

FIG. 1 is a simplified block diagram illustrating the general operations of the automated financial document processing and bookkeeping system and method according to one embodiment of the present disclosure;

FIG. 2 is a more detailed block diagram illustrating the general operations of the automated financial document processing and bookkeeping system and method according to one embodiment of the present disclosure;

FIG. 3 is a more detailed illustration of the operations of the dynamotator process of the automated financial document processing and bookkeeping system and method according to one embodiment of the present disclosure;

FIG. 4 are example screen shots of a mobile application executing on a mobile device used to capture and organize financial documents of the automated financial document processing and bookkeeping system and method according to one embodiment of the present disclosure;

FIG. 5 is a flow diagram illustrating an example automated financial document capture process of the automated financial document processing and bookkeeping system and method according to one embodiment of the present disclosure;

FIG. 6 is a flow diagram illustrating an example automated proof of delivery document capture and processing process of the automated financial document processing and bookkeeping system and method according to one embodiment of the present disclosure;

FIG. 7 is a flow diagram illustrating an example automated general ledger entry process of the automated financial document processing and bookkeeping system and method according to one embodiment of the present disclosure;

FIG. 8 is a flow diagram illustrating an example financial risk score process of the automated financial document processing and bookkeeping system and method according to one embodiment of the present disclosure; and

FIG. 9 is a diagram illustrating an automatic accounting file system and mobile digital file cabinet user interface of the automated financial document processing and bookkeeping system and method according to one embodiment of the present disclosure.

### DETAILED DESCRIPTION

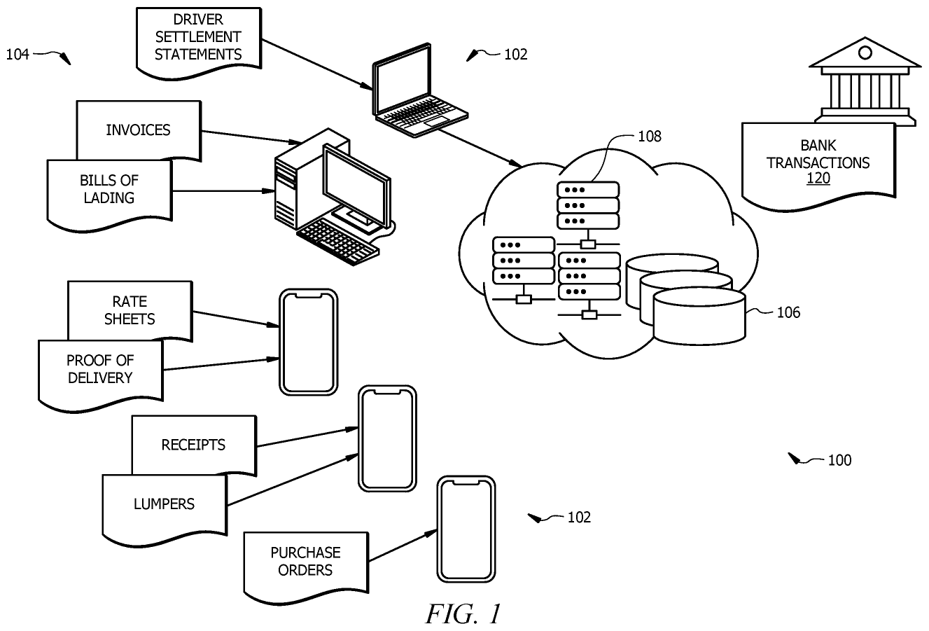

FIG. 1 is a simplified block diagram illustrating the general operations of the automated financial records processing and bookkeeping system and method 100 according to one embodiment of the present disclosure. The system 100 includes software, a web browser-based interface, and/or a mobile application that execute on computing devices 102, including mobile devices, laptop computers, notebook computers, and desktop computers that can be used to capture or scan images of financial documents 104, that are then wirelessly uploaded and stored in databas(es) 106 in the cloud via WiFi and cellular networks etc. for analysis, processing, and storage. Document data may also be entered manually and transmitted to the server(s) 108 in the cloud and stored in databases 106. These financial documents 104 may include, for example, invoices, bills of lading, lumper receipts, rate sheets, proof of delivery, receipts, purchase orders, bank statements, and driver settlement statements. Moreover, the servers 108 and databases 106 may also receive the user's banking transaction data 120 via connections to banking institutions or third-party service providers.

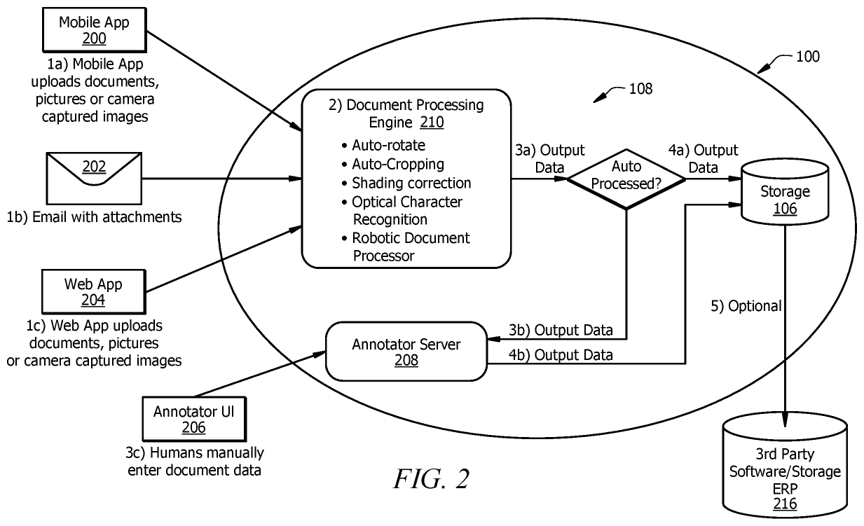

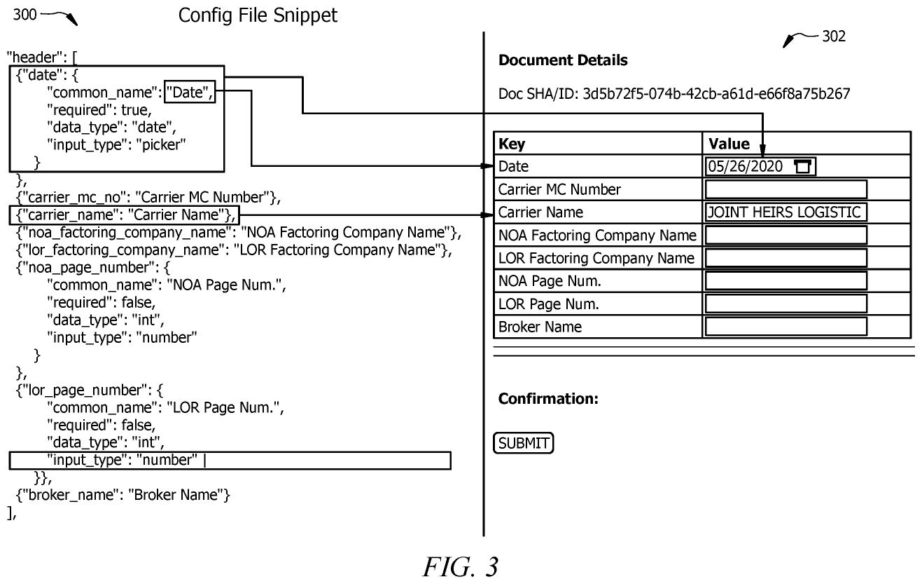

FIG. 2 is a more detailed block diagram illustrating the general operations of the automated financial records processing and bookkeeping system and method 100 according to one embodiment of the present disclosure. The financial document 104 can be uploaded or transmitted to the cloud-based server(s) 108 and databas(es) 106 in a number of ways. A mobile application 200 executing on a mobile computing device may be used to capture images of a financial document using a camera utility resident on the mobile device and then uploaded to the servers 108 and databases 16. The financial document images can also be transmitted as an attachment to another form of electronic communication, such as an email or a text message 202 sent, for example, to a predesignated email address or telephone number. A web application or web-browser interface 204 may be used to upload a scanned or captured image of a financial document. A user may also enter data associated with a financial transaction via an annotator user interface (UI) 206, which are then received by an annotator server 208 and stored in the database 106. Details of the annotator function are shown in FIG. 3 and described below. Optionally, the server 108 and database 106 may be configured to communicate extracted and analyzed data to a third party ERP (enterprise resource planning) software or storage 216.

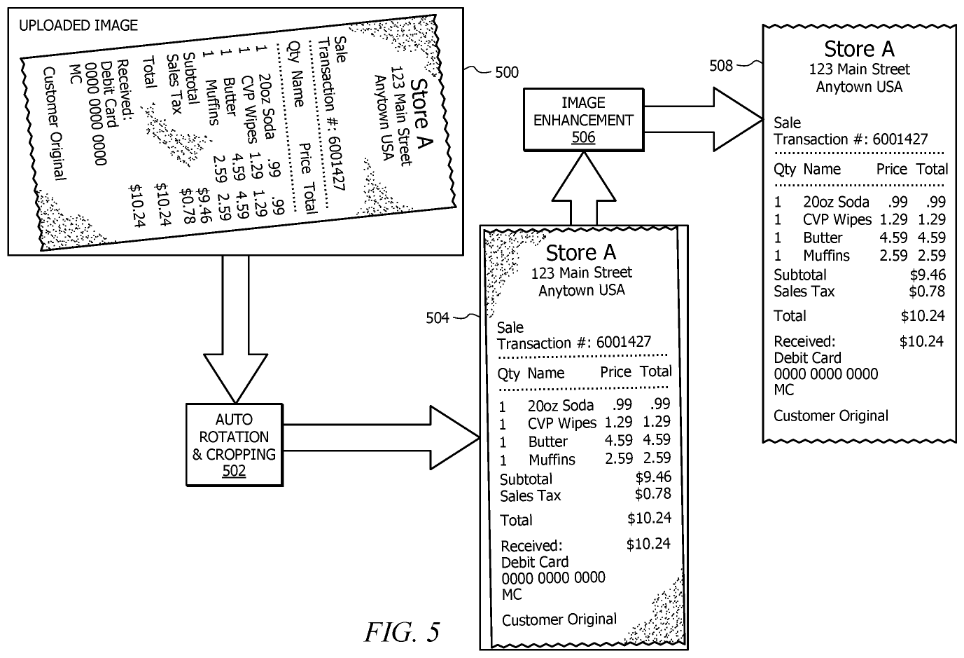

System and method 100 include a document processing engine 210 used to automate and perform a number of functions on the captured images of financial documents. As shown in FIG. 5, the uploaded images 500 are automatically rotate the images to the correct orientation and crop the images, as shown in block 502. The images 504 are also processed to enhance the visibility and clarity of the data (e.g., edge, detection, shading correction, increase contrast, increase sharpness), as shown in block 506. The document processing engine 210 further performs optical character recognition (OCR) to convert the images 508 to text files. The processing engine 210 can also automatically recognize that multiple images constitutes different pages or portions of the same document, and assemble them into a single document. The processing engine 210 uses machine learning (ML) and/or artificial intelligence (AI) to extract certain information from the processed images or text files. The document processing engine 210 also automatically analyzes the images and classifies the document types (e.g., invoices, bills of lading, rate sheets, proof of delivery, lumpers, receipts, purchase orders, bank statements, and driver settlement statements), so that the user doesn't have to specify the document types when uploading or sending the images. The documents can be further sorted according to other criteria, such as the type of purchase for invoices, and grouping the document with the load package it is associated with. Transactions are mapped to an industry-specific chart of accounts according to accounting standards for proper bookkeeping. The document processing engine 210 is further able to recognize if duplicates of the same documents have been received and eliminate duplication. For example, metadata key values from incoming transactions are compared to the metadata of all existing images in the database for a particular user (carrier or owner-operator) to automatically reconcile document images with bank transactions (automatically synchronized with banking institutions on a periodic basis, e.g., daily) to verify the documents and identify duplicates. The financial information in each type of recognized type of document is extracted and used according to predetermined process flows. The images and extracted information are stored in the database 106 and organized and accessible by the users using a mobile filing system, describe below. Data redundancy may be achieved by storing the data in one or more mirror servers and databases.

As shown in FIG. 2, the annotator server 208 serves two primary functions. It serves as a quality control process after the automatic processing of the incoming document images by the processing engine 210, and it also serves to process manually-entered document data via the annotator user interface 206. Typically, documents are automatically processed by the document processing engine 210 without human intervention. However, when there is missing or incorrect data in the extracted information, the annotator server 208 enables the output data from the processing engine 210 to be corrected before the data is transmitted to the final destination (e.g., database 106 and/or another business entity or institution).

The annotator server 208 is a tool to enhance data quality after document images digitization by the process engine 210 as well as manually-entered data via the annotator user interface 206. As shown in FIG. 3, a config file 300 (partial config file shown) is defined for each client (e.g., a carrier) that specifies what data fields on each type of document need to be captured from automatic document processing or manual entry, the operations (e.g., math or string manipulation) that need to be performed on the data in each data field, and the desired user interface layout and format of those data fields. The config file 300 is parsed by an interpreter program module that dynamically renders a custom layout 302 for the annotator user interface on a display of a computing device for a user/client, such as shown in FIG. 3. Each comma-separated curly-brace block in the config file 300 represents a single row in the right-side table in the user interface layout 302. For example, the name of the carrier is a required data field. The carrier name block for the Carrier Name permits text input. No special enforcement on the Carrier Name data is needed. As another example, the Date block requires special enforcements. The Date is also a required data field. The common name field represents the human readable name to put in the Key column of the table. The entirety of the Date block informs the annotator user interface 206 what type of input fields to display to the user. Modern web browsers offer several types of input fields, such as plain text, a number counter, drop-down lists, a date picker, and many others. By default, an input field will be plain text, but this the Date block tells the user interface to use a date picker for this particular row (as noted by the combination of the ‘data type’ and ‘input type’). The annotator is designed to piggyback on an existing data pipeline, rather than insert itself directly into it. If the client already has a working ERP (enterprise resource planning) system, the presence of the annotator allows the user to utilize the annotator or their own ERP tool at any time. This allows for extracting the data at a certain point of the data pipeline, alter it, and insert it back into the database.

For example, an existing workflow may include:

1. A document is scanned/uploaded into a company's ERP system;

2. A company employee views that document in the ERP's user interface;

3. Employee picks out the relevant data from the document and enters it into the ERP user interface;

4. Employee clicks a submit button, and the user interface returns the modified document to the ERP system, sending it to the next step in the pipeline.

Inserting the annotator into the workflow may modify the workflow:

1. A document is scanned/uploaded into a company's ERP system;

2. An employee can choose whether to use the existing ERP user interface or use the annotator to retrieve the document from the queue. Both user interfaces can look the same;

3. Regardless of which user interface, the employee picks out and enters data into a web form;

4. User submits the extracted data. If the user is using the existing ERP user interface, the process is the same as before. If the user is using the annotator user interface instead, it will parse the information and attempt to make it adhere to the desired data structure before sending it to the same place as the existing ERP user interface.

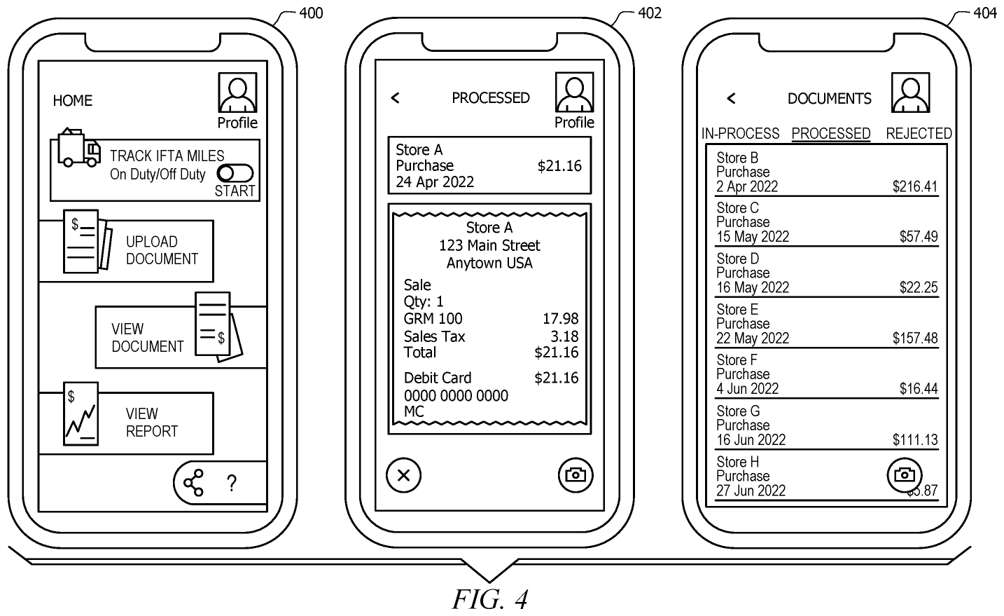

FIG. 4 are example screen shots 400-404 of a mobile application 200 executing on a mobile computing device that may be used to capture and organize financial documents 104 according to one embodiment of the present disclosure. The mobile app 200 provides a simple and easy-to-use user interface 400 to enable a user to capture and upload a financial document, view a stored document, and view reports associated with financial transactions (mobile digital file cabinet function). The capture image interface 402 of the mobile application 200 enables the user to take a picture of the financial document, in this example, a receipt of a purchase, and upload the image to the server 108 for storage in the database 106. The document processing engine 210 residing in the cloud automatically processes each captured image, extracts information from the document image (e.g., merchant name, payment channel, authorized date, processed date, merchant address, merchant city, state and zip code, currency code, and receipt amount) creates a new financial record corresponding to the uploaded image/financial document. Using a reporting function of the mobile application 200, the user may view stored images and data associated with the uploaded financial documents. The reporting (file cabinet) user interface 404 presents a list of uploaded and processed documents that the user can scroll and select for viewing. The user can manipulate the displayed document image (e.g., zoom in and out) and to see specific parts of the document. The document list can be filtered by date range or other parameters to facilitate searching. The user can also download the document images, and transmit them via email, text, or another suitable method. The user interface further includes a toggle button to track mileage and automatically tabulate IFTA taxes.

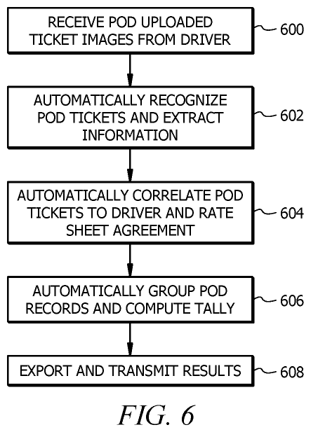

FIG. 6 is a flow diagram illustrating an example automated proof of delivery (POD) document capture and processing process according to one embodiment of the present disclosure. The driver takes a picture of the POD ticket and the captured image is automatically uploaded to the server and processed by the document processing engine 210 in the cloud, as shown in block 600. After image processing and recognition, the POD tickets are automatically correlated to the driver that submitted those tickets and the rate sheet agreements on file, as shown in block 602 and 604. The document processing engine 210 groups the POD records and tallies outgoing itemized invoices, as shown in block 606. The results are then exported by the document processing engine, as shown in block 608. The results may include a collection of POD records and the automatically generated invoices. This results data is then transmitted electronically to financial institutions such as banks and freight factoring companies. A freight factoring company in the trucking industry specializes in invoice factoring, which purchases outstanding invoices from carriers or owner-operators that have slow paying customers or brokers and are looking to boost cash flow. This allows a business to access cash immediately after issuing an invoice, instead of waiting 30-90 days for the customer to pay.

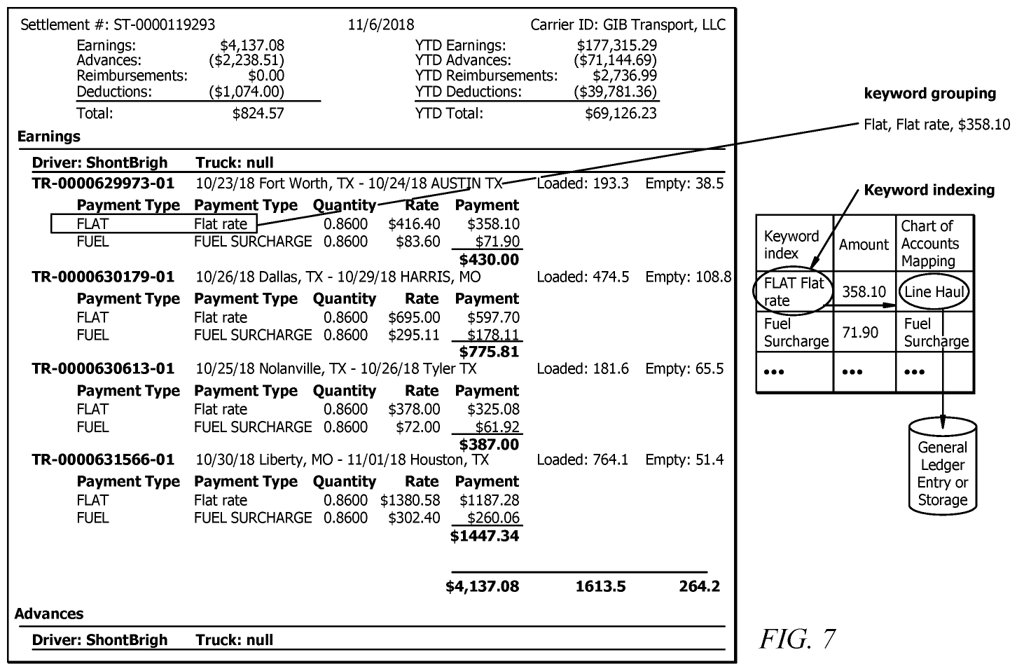

FIG. 7 is a flow diagram illustrating an example automated general ledger entry process according to one embodiment of the present disclosure. As mentioned above, the document processing engine 210 is able to automatically analyze the enhanced images, convert the images to text files, and recognize and classify the types of financial documents being processed. The document processing engine 210 is able to contextualize data items in the captured image using techniques including keyword grouping, keyword indexing, index output mapping to a chart of accounts entry, and data submission to a general ledger. Although each client company that uses system and method 10 has their own unique document format, the data present in each type of document is fairly standard and known. The document processing engine 210 can, using machine learning and/or artificial intelligence, be trained or configured to recognize the types of financial documents for each company and to recognize the keywords, formats, and locations etc. of data items that need to be extracted. After data extraction, the document processing engine software 210 will also automatically calculate financial information and generate the appropriate reports, such as a balance sheet, profit and loss report, expense report, year-to-date self-employment and federal tax liabilities, and International Fuel Tax Agreement (IFTA) report. No data entry is required to categorize uploaded income and expenses into a general ledger as the document processing engine 210 performs this function automatically.

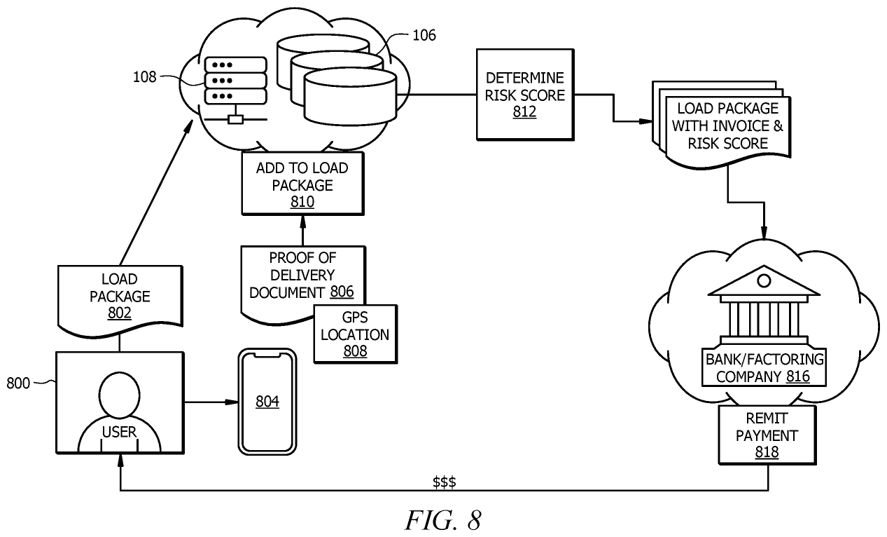

FIG. 8 is a flow diagram illustrating an example financial risk score process according to one embodiment of the present disclosure. A user (carrier or owner-operator) 800 uploads a load package 802 to the server 108 that includes documentation relevant to the transportation of a certain load of goods. This may include, for example, a contract between a carrier and a shipper called a rate confirmation. The system and method 100 then automatically process the documents in the load package 802 by extracting specific data related to this particular shipment and stores the data in the database 106. When the driver arrives at the shipment destination, they use their mobile device 804 to capture and upload the image of delivery confirmation documentation 806 at the time and place of delivery. For example, the proof of delivery document may be a bill of lading or any document that can verify delivery has been made. Whenever the proof of delivery documentation is uploaded, the geographical location (e.g., global positioning system or GPS location) 808 of the user's mobile device 804 is also recorded and transmitted along with the documentation. The proof of delivery documentation 806 and geographical location 808 are uploaded to the server 108 and added to the load package stored in the database 106, as shown in block 810. The server 108 includes a logic module that automatically organizes the load documents in the load package, verifies whether these documents are sufficient for payment, and provides helpful feedback. The logic module then determines a risk score based on the contents of the load package, proof of delivery documents, geographical location, and other data, as shown in block 812. The risk score along with the load package and an invoice for the full contracted amount 814 are then automatically provided or transmitted to a financial/banking institution or a freight factoring company 816 for payment. The risk score represents a percent confidence rating that the full invoiced amount will be paid by the shipper.

In a typical scenario, the financial/banking institutions or freight factoring companies employ personnel to review the load package and invoice to look for any misalignment of data, verify that the proper documentation is present, and validate the invoiced amount for payment. This manual process introduces delay in how quickly the carrier or owner-operator can be paid. By providing a risk score to the bank or factoring company payor, the system and method 100 enables the payor to purchase the invoice and remit payment to the user 800 with less investment in time and labor, resulting in an overall reduction in cost and delay, as shown in block 818.

The risk score may be computed based on the rate confirmation, proof of delivery documentation, and geolocation at time of load delivery. Additionally, the risk score may also be based on the receipts uploaded by the driver along the route, e.g., whether the locations and timing of fuel purchases are consistent with the route from the starting location to the destination. Another data point for consideration is whether the bill of lading geolocation uploaded at each delivery point is consistent with the driven route. If available, the geolocation tracking information of the truck may also be used to verify the proof of delivery and compute the risk score.

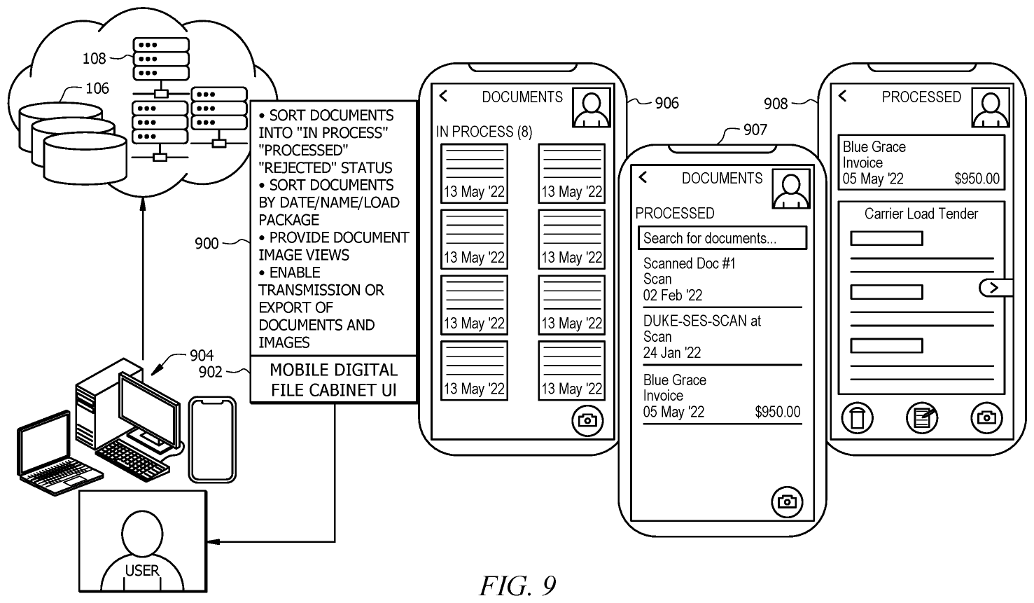

FIG. 9 is a diagram illustrating an automatic accounting file system 900 and mobile digital file cabinet user interface 902 according to one embodiment of the present disclosure. The automatic accounting file system module 900 automatically sorts all documents uploaded by a user into three status categories: in process, processed, and rejected. An uploaded document may be rejected because the image is not clear, the document is not relevant, or it's a duplication. The mobile digital file cabinet user interface 902 enables a user to have easy access to their uploaded documents and images by the status categories via any form of computing device 904 capable of rendering the user interface screens. The user may view the image, pdf file, and/or text file associated with every uploaded document. For example, example screen 906 provides a list of documents that are in process. The user may also enter keywords to search documents in each category, as shown in screen 907. Screen 908 shows an example screen of a detailed view of an uploaded document, such as a Carrier Load Tender document identified by the system as an invoice for the amount of $950. All pages of the document are available for viewing and access by the user. The mobile file cabinet user interface also enables the user to download, print, email, etc. of the documents.

The automated financial document processing and bookkeeping system and method described herein enables a user, such as a carrier or an owner-operator, to automate back office and bookkeeping functions The user can easily upload receipts and other financial documents that are automatically processed and useful data extracted from these documents to be used in financial records and reports. The system and method also automatically calculate a risk score for a delivered load that enables a bank or a factoring company to automate the decision of whether to pay for the full invoiced amount for the delivered load. This process further helps to reduce the amount of time that will be needed for the user to get paid for the delivered load.

The features of the present invention which are believed to be novel are set forth below with particularity in the appended claims. However, modifications, variations, and changes to the exemplary embodiments described above will be apparent to those skilled in the art, and the system and method described herein thus encompasses such modifications, variations, and changes and are not limited to the specific embodiments described herein.

What is claimed is:

1. An automated financial document processing and bookkeeping system, comprising:
a user application having an interface configured to capture images of financial documents associated with a user and transmit the document images to a remote server, the financial documents selected from the group consisting of invoices, bills of lading, rate sheets, proof of delivery, lumper, receipts, purchase orders, bank statements, and driver settlement statements;
the remote server having a document processing engine configured to receive the document images, automatically enhance the document images, automatically recognize text in the document images, automatically convert the document images to text documents, automatically classify the text document, automatically extract specific data items from the text documents, automatically generate financial records incorporating the extracted specific data items, and automatically incorporate financial transactions represented in the financial records in an electronic general ledger for the user;
a database in communication with the remote server and configured to store the document images, text documents, and financial records;
the user application having a mobile file cabinet user interface configured to enable the user to access and view the stored document images and financial records; and
the user application having a reporting user interface configured to enable the user to generate and view a report selected from the group consisting of balance sheet, profit and loss, expenses, year-to-date self-employment tax liability, year-to-date federal tax liability, and International Fuel Tax Agreement (IFTA) report.

2. The system of claim 1, further comprising a risk score module configured to analyze data associated with a delivered load including the proof of delivery and determine a risk score representing a confidence level associated with full payment by a shipper for the delivered load.

3. The system of claim 2, wherein the risk score module is further configured to automatically transmit the risk score and financial documents associated with the delivered load to a payor.

4. The system of claim 1, further comprising an annotator configured to receive a configuration file identifying a plurality of data fields of each type of financial document, the type of data for each data field, manipulation needed for each data field, and specifying a user interface layout for the plurality of data fields, the annotator instructing the mobile file cabinet user interface to display the data fields according to the user interface layout.

5. The system of claim 4, wherein the annotator is further configured to receive the financial records generated by the document processing engine, automatically recognizing duplicate financial records, automatically determine missing or incorrect data in the financial records, and automatically instruct an annotator user interface to display the plurality of data fields and enable a user to enter or correct data.

7. The system of claim 1, wherein the document processing engine is configured to automatically enhance the document images by performing at least one of rotation, edge detection, cropping, and shading correction.

8. The system of claim 1, wherein the remote server automatically receives bank transaction data from at least one financial institution, and the document processing engine automatically reconciling the bank transaction data with financial records stored in the database to detect and remove duplicate financial data.

9. An automated financial document processing and bookkeeping system, comprising:
a user application having an interface configured to capture images of financial documents associated with a user and transmit the document images to a remote server, the financial documents selected from the group consisting of invoices, bills of lading, rate sheets, proof of delivery, lumper, receipts, purchase orders, bank statements, and driver settlement statements;
the remote server having a document processing engine configured to receive the document images, automatically enhance the document images, automatically recognize text in the document images, and automatically convert the document images to text documents, automatically classify the text document, automatically extract specific data items from the text documents, and automatically generate financial records incorporating the extracted specific data items;
a database in communication with the remote server and configured to store the document images, text documents, and financial records;
a risk score module configured to analyze data associated with a delivered load including the proof of delivery and determine a risk score representing a confidence level associated with full payment by a shipper for the delivered load; and
the risk score module further configured to automatically transmit the risk score and financial documents associated with the delivered load to a payor.

10. The system of claim 9, further comprising:
the user application having a mobile file cabinet user interface configured to enable the user to access and view the stored document images and financial records; and
the user application having a reporting user interface configured to enable the user to generate and view a report selected from the group consisting of balance sheet, profit and loss, expenses, year-to-date self-employment tax liability, year-to-date federal tax liability, and International Fuel Tax Agreement (IFTA) report.

11. The system of claim 9, further comprising an annotator configured to receive a configuration file identifying a plurality of data fields of each type of financial document, the type of data for each data field, manipulation needed for each data field, and specifying a user interface layout for the plurality of data fields, the annotator instructing the mobile file cabinet user interface to display the data fields according to the user interface layout.

12. The system of claim 11, wherein the annotator is further configured to receive the financial records generated by the document processing engine, automatically recognizing duplicate financial records, automatically determine missing or incorrect data in the financial records, and automatically instruct an annotator user interface to display the plurality of data fields to enable a user to enter or correct data.

13. An automated method for financial document processing and bookkeeping, comprising:
capturing, at a mobile computing device, images of financial documents selected from the group consisting of invoices, bills of lading, rate sheets, proof of delivery, lumper, receipts, purchase orders, bank statements, and driver settlement statements;
transmitting the document images to a remote server;
at a remote server:
automatically enhancing the document images;
automatically recognizing text in the document images;
automatically converting the document images to text documents;
automatically classifying the text document;
automatically extracting specific data items from the text documents;
automatically generating financial records incorporating the extracted specific data items;
automatically incorporating the financial transaction represented in each financial record in an electronic general ledger;
storing the document images, text documents, and financial records, and enabling the user to generate and view a report selected from the group consisting of balance sheet, profit and loss, expenses, year-to-date self-employment tax liability, year-to-date federal tax liability, and International Fuel Tax Agreement (IFTA) report.

14. The method of claim 13, further comprising:
receiving a configuration file identifying a plurality of data fields of each type of financial document, the type of data for each data field, manipulation needed for each data field, and specifying a user interface layout for the plurality of data fields; and
instructing a user interface to display the data fields according to the user interface layout.

15. The method of claim 13, further comprising:
receiving the financial records;
automatically determining missing or incorrect data in the financial records; and
automatically instructing the user interface to display the plurality of data fields and enable a user to enter or correct data.

16. The method of claim 13, further comprising:
receiving the proof of delivery for a delivered load at the remote server;
extracting data items from the proof of delivery;
receiving a geolocation of a mobile device that transmitted the proof of delivery to the remote server;
analyzing the extracted data items associated with the delivered load including the proof of delivery, the rate sheet, the invoice, and the geolocation; and
determining a risk score representing a confidence level associated with full payment of the invoice for the delivered load by a shipper.

17. The method of claim 16, further comprising automatically transmitting the risk score and financial documents associated with the delivered load to a factoring payor.

18. The method of claim 13, further comprising:
automatically sorting the uploaded financial documents indicative of processing status of each financial document; and
displaying a list of uploaded financial documents having a specified processing status responsive to a user's selection input.

19. The method of claim 16, further comprising:
uploading, at a mobile device, a proof of delivery for a delivered load to the remote server; and
determining and transmitting to the remote server a geolocation of the mobile device at the time of uploading the proof of delivery.
